(19) United States
(12) Patent Application Publication
(10) Pub. No.: US 2025/0272586 A1
(43) Pub. Date: Aug. 28, 2025

(54) TECHNIQUES FOR DESIGNING SYSTEMS WITH MULTI-OBJECTIVE BAYESIAN OPTIMIZATION

(71) Applicant: NVIDIA CORPORATION, Santa Clara, CA (US)

(72) Inventor: Chien-Yi WANG, New Taipei City (TW)

(21) Appl. No.: 18/903,696

(22) Filed: Oct. 1, 2024

Related U.S. Application Data
(60) Provisional application No. 63/559,146, filed on Feb. 28, 2024.

(51) Int. Cl. G06N 7/01

(52) U.S. Cl. CPC G06N 7/01

(57) ABSTRACT

One embodiment of a method for designing a system includes processing historical data associated with zero or more previous designs of the system using a trained machine learning model to predict a plurality of rewards for a plurality of designs of the system that are associated with different combinations of parameter values, and selecting, from the plurality of designs of the system, a first design of the system that is associated with a highest reward included in the plurality of rewards.

### CROSS-REFERENCE TO RELATED APPLICATIONS

This application claims benefit of the United States Provisional Patent Application titled “GENERALIZED DEEP Q-LEARNING FRAMEWORK FOR MULTI-OBJECTIVE BAYESIAN OPTIMIZATION,” filed Feb. 28, 2024, and having Ser. No. 63/559,146. The subject matter of this related application is hereby incorporated herein by reference.

### BACKGROUND

### Field of the Various Embodiments

The embodiments of the present disclosure relate generally to the fields of computer science, machine learning and artificial intelligence (AI), and more specifically, to techniques for designing systems with multi-objective Bayesian optimization.

### Description of the Related Art

Systems oftentimes include controllable factors, referred to as “parameters,” that can be adjusted to achieve various performance objectives. For example, the parameters of an integrated circuit can include the number of resistors, the number of capacitors, a bias current, a width/length (W/L) ratio, among other things. Such parameters can be adjusted to achieve performance objectives such as minimizing power consumption by the integrated circuit, maximizing the gain between an output signal and input signal, maximizing a unity-gain bandwidth, and/or the like. Adjusting the parameters of a system to achieve desired performance objectives is also referred to as optimizing the parameters.

One approach for optimizing the parameters of a system is through manual trial-and-error using different simulations of the system. A manual trial-and-error process normally involves a designer adjusting values of the parameters by hand, and then running simulations using the adjusted values and observing how changes in the parameter values affect the performance of the system. By systematically adjusting one or more parameters and analyzing the outcomes, the designer can identify trends and make informed decisions about further adjustments.

One drawback of the above approach for optimizing the parameters of a system is that manual trial-and-error is time-consuming, and this approach oftentimes does not result in the optimal values for the parameters of a given system actually being identified. Notably, few if any, automated techniques currently exist for optimizing the various parameters of a system, particularly when the parameters are being optimized to improve multiple performance criteria simultaneously. In such cases, the different trade-offs across the multiple performance criteria have to be considered during the parameter optimization. Because there are no automated techniques for evaluating such trade-offs, designers currently have to manually assess the trade-offs based on personal experience and expertise in designing systems. Again, such a manual and subjective approach oftentimes results in sub-optimal system parameter selection, which, in turn, can result in sub-optimal system performance.

As the foregoing illustrates, what is needed in the art are more effective techniques for designing systems.

### SUMMARY

One embodiment of the present disclosure sets forth a computer-implemented method for designing a system. The method includes processing historical data associated with zero or more previous designs of the system using a trained machine learning model to predict a plurality of rewards for a plurality of designs of the system that are associated with different combinations of parameter values. The method further includes selecting, from the plurality of designs of the system, a first design of the system that is associated with a highest reward included in the plurality of rewards.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, more optimal parameter values for a system can be selected relative to manual trial-and-error, resulting in improved performance of the system being designed across multiple performance criteria. In addition, the automatic optimization can converge to a solution relatively quickly by accounting for the history of previous designs that have been considered during optimization. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the machine learning server of FIG. 1, according to various embodiments;

FIG. 3 is a more detailed illustration of the computing system of FIG. 1, according to various embodiments;

FIG. 4 is a more detailed illustration of the model trainer of FIG. 1, according to various embodiments;

FIG. 5 is a more detailed illustration of the machine learning model of FIG. 1, according to various embodiments;

FIG. 6 illustrates an exemplar sequence of actions that increases a hypervolume, according to various embodiments;

FIG. 7 is a more detailed illustration of the design application of FIG. 1, according to various embodiments;

FIG. 8 is a flow diagram of method steps for training a machine learning model to design a system, according to various embodiments; and

FIG. 9 is a flow diagram of method steps for designing a system using a trained machine learning model, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for training and using a machine learning model to design systems, such as integrated circuits. In some embodiments, the machine learning model is a transformer-based neural network that a model trainer trains for a number of episodes. During each episode, the model trainer trains the machine learning model by, for each of a number of iterations, processing historical data and potential observation-action pairs using the machine learning model to predict rewards for actions that represent designs of a system using different parameter values, and updating the historical data based on the action associated with the highest predicted reward. In addition, for each episode, the model trainer computes a loss based on a comparison between the predicted rewards during the episode and rewards for the actions that are computed using a simulator, and then the model trainer updates parameters of the machine learning model based on the computed loss. Once training is complete, a design application can use the trained machine learning model to optimize the design of a system by, for each of a number of iterations, processing historical data and potential observation-action pairs using the trained machine learning model to predict rewards for actions that represent designs of the system using different parameter values, selecting an action associated with the highest predicted reward, computing a reward for the selected action using a simulation, and updating the historical data with the selected action and resulting design, the highest predicted reward, and the simulation reward.

The techniques for training and using a machine learning model to design systems have many practical applications. For example, those techniques could be used to design systems, such as integrated circuits, that include multiple tunable parameters. As another example, those techniques could be used to optimize the hyperparameters used to train a machine learning model.

The above examples are not in any way intended to be limiting. As persons skilled in the art will appreciate, as a general matter, the techniques for training and using a machine learning model to design systems described herein can be implemented in any suitable application.

### System Overview

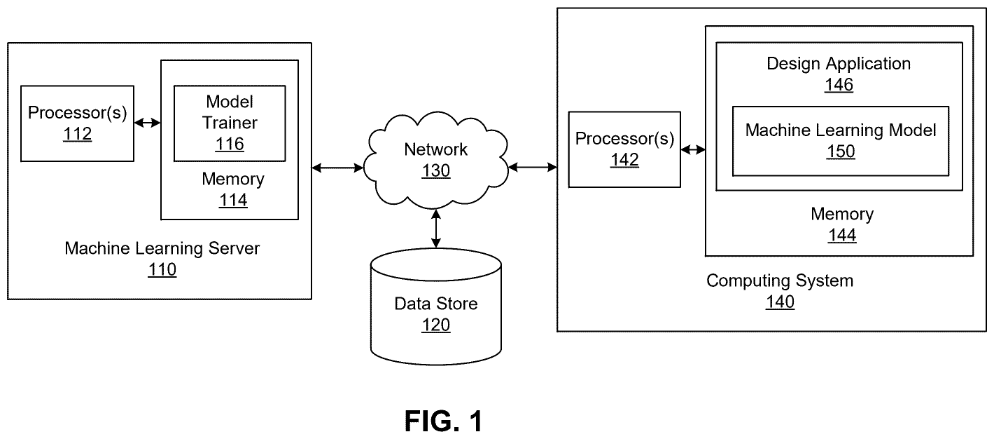

FIG. 1 illustrates a block diagram of a computer-based system 100 configured to implement one or more aspects of various embodiments. As shown, the system 100 includes a machine learning server 110, a data store 120, and a computing system 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the processor(s) 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

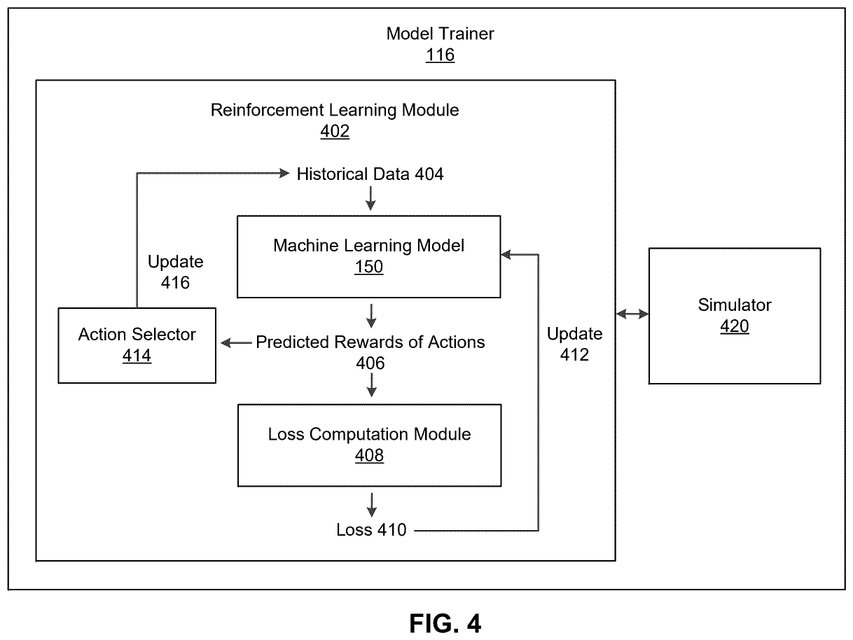

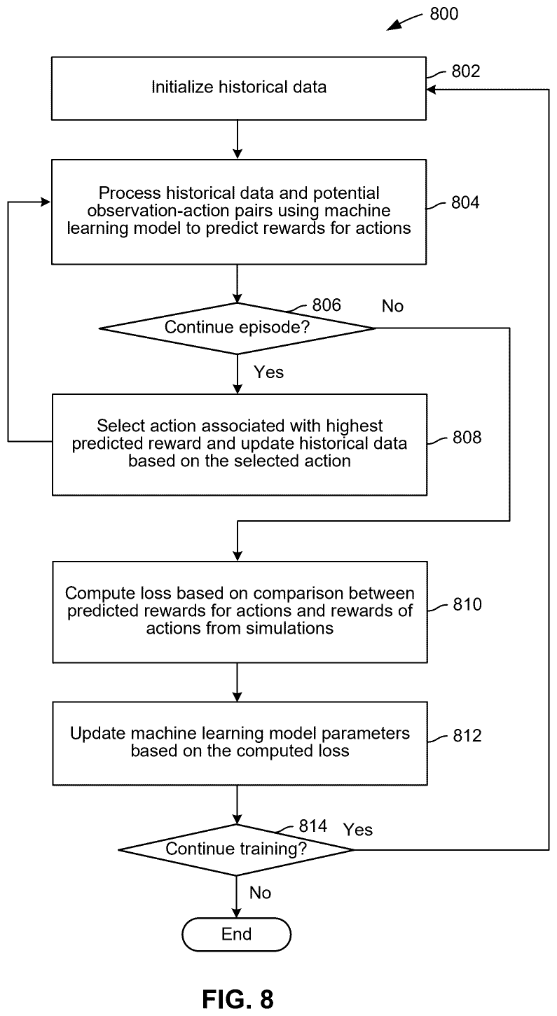

In some embodiments, the model trainer 116 is configured to train a machine learning model 150 that can be used to design a system by iteratively optimizing parameters of the system. Techniques that the model trainer 116 can employ to train the machine learning model 150 are discussed in greater detail below in conjunction with FIGS. 4 and 8. Training data and/or trained (or deployed) machine learning models, including the machine learning model 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

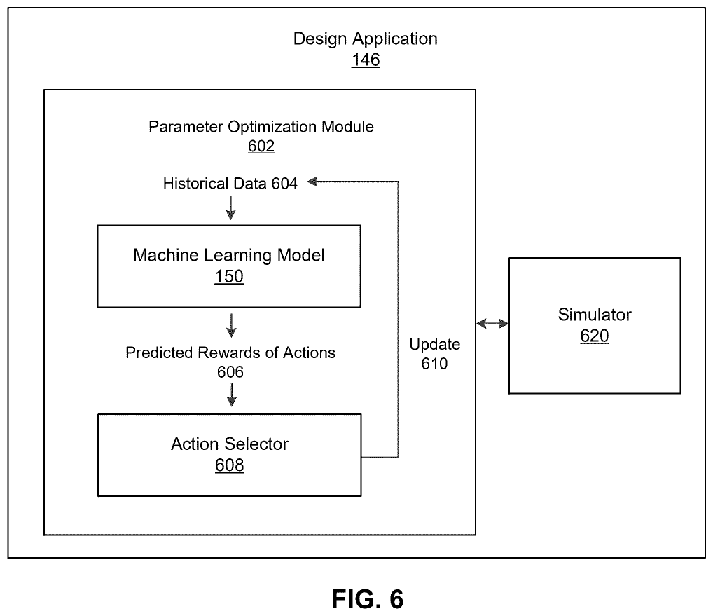

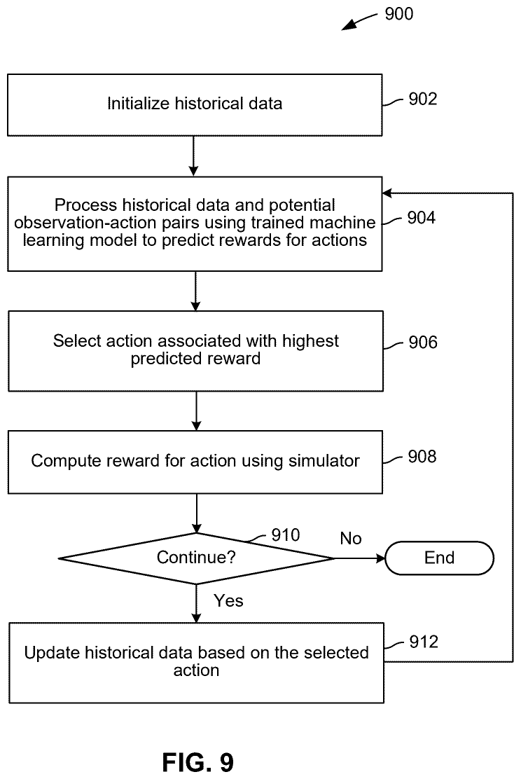

As shown, a design application 146 that uses the machine learning model 150 is stored in a system memory 144, and executes on a processor 142, of the computing system 140. Once trained, the machine learning model 150 can be deployed in any suitable application, such as the design application 146. Techniques that the design application 146 can perform to design a system using the machine learning model 150 are discussed in greater detail below in conjunction with FIGS. 6 and 9.

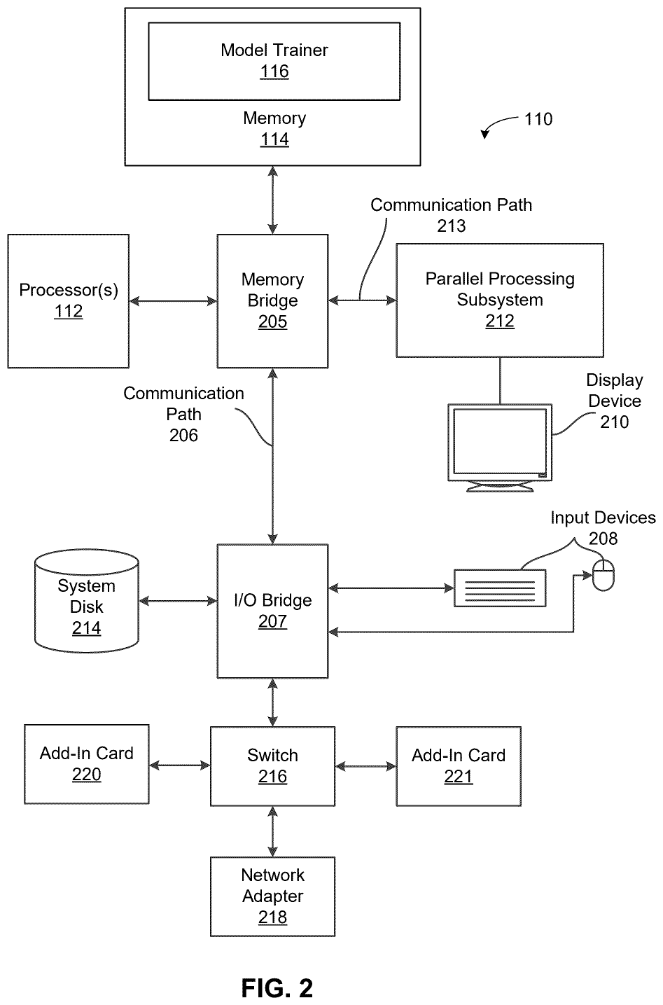

FIG. 2 is a more detailed illustration of the machine learning server 110 of FIG. 1, according to various embodiments. In some embodiments, the machine learning server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In some embodiments, the machine learning server 110 includes, without limitation, the processor(s) 112 and the memory(ies) 114 coupled to a parallel processing subsystem 212 via a memory bridge 205 and a communication path 206. Memory bridge 205 is further coupled to an I/O (input/output) bridge 207 via a communication path 206, and I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 can be a server machine in a cloud computing environment. In such embodiments, the machine learning server 110 can not include input devices 208, but can receive equivalent input information by receiving commands (e.g., responsive to one or more inputs from a remote computing device) in the form of messages transmitted over a network and received via a network adapter 218. In some embodiments, the switch 216 is configured to provide connections between I/O bridge 207 and other components of the machine learning server 110, such as a network adapter 218 and various add in cards 220 and 221.

In some embodiments, the I/O bridge 207 is coupled to a system disk 214 that may be configured to store content and applications and data for use by the processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, can be implemented using any technically suitable protocols, including, without limitation, AGP (Accelerated Graphics Port), HyperTransport, or any other bus or point to point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations.

The system memory 114 includes at least one device driver configured to manage the processing operations of the one or more PPUs within the parallel processing subsystem 212. In addition, the system memory 114 includes the model trainer 116, discussed in greater detail below in conjunction with FIGS. 4 and 8. Although described herein primarily with respect to the model trainer 116, techniques disclosed herein can also be implemented, either entirely or in part, in other software and/or hardware, such as in the parallel processing subsystem 212.

In some embodiments, the parallel processing subsystem 212 can be integrated with one or more of the other elements of FIG. 2 to form a single system. For example, the parallel processing subsystem 212 can be integrated with the processor(s) 112 and other connection circuitry on a single chip to form a system on a chip (SoC).

In some embodiments, the processor(s) 112 includes the primary processor of the machine learning server 110, controlling and coordinating operations of other system components. In some embodiments, the processor(s) 112 issues commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, can be modified as desired. For example, in some embodiments, the system memory 114 could be connected to the processor(s) 112 directly rather than through the memory bridge 205, and other devices can communicate with the system memory 114 via the memory bridge 205 and the processor(s) 112. In other embodiments, the parallel processing subsystem 212 can be connected to the I/O bridge 207 or directly to the processor(s) 112, rather than to the memory bridge 205. In still other embodiments, the I/O bridge 207 and the memory bridge 205 can be integrated into a single chip instead of existing as one or more discrete devices. In certain embodiments, one or more components shown in FIG. 2 may not be present. For example, the switch 216 could be eliminated, and the network adapter 218 and add in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

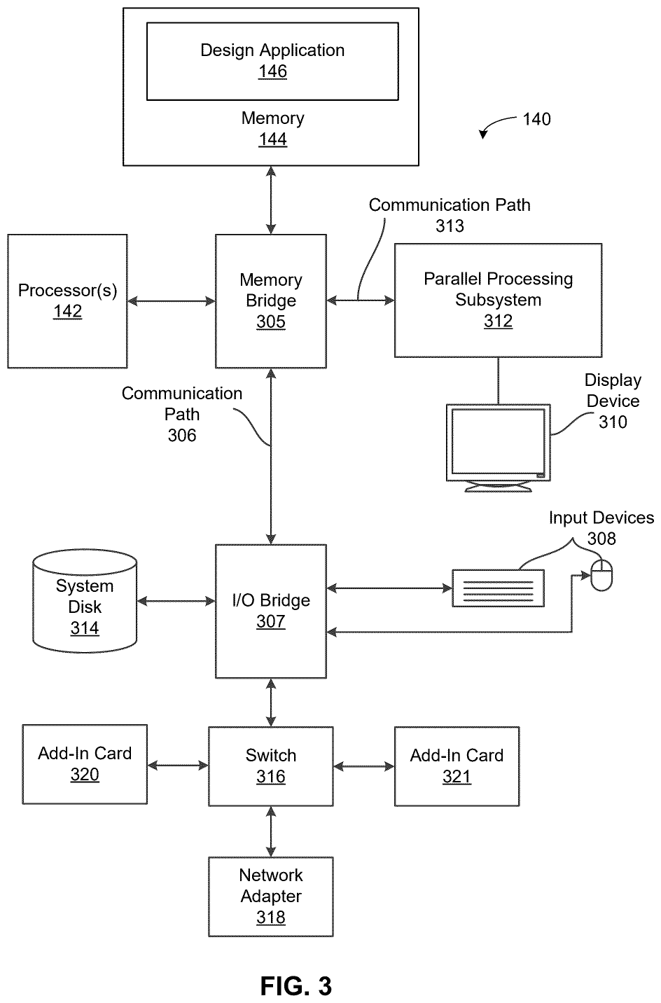

FIG. 3 is a more detailed illustration of the computing system 140 of FIG. 1, according to various embodiments. In some embodiments, the computing system 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing system 140 is a server machine operating in a data center or a cloud computing environment that provides scalable computing resources as a service over a network.

In some embodiments, the computing system 140 includes, without limitation, the processor(s) 142 and the memory (ies) 144 coupled to a parallel processing subsystem 312 via a memory bridge 305 and a communication path 306. Memory bridge 305 is further coupled to an I/O (input/output) bridge 307 via a communication path 306, and I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing system 140 can be a server machine in a cloud computing environment. In such embodiments, the computing system 140 can not include the input devices 308, but can receive equivalent input information by receiving commands (e.g., responsive to one or more inputs from a remote computing device) in the form of messages transmitted over a network and received via a network adapter 318. In some embodiments, the switch 316 is configured to provide connections between I/O bridge 307 and other components of the computing system 140, such as a network adapter 318 and various add in cards 320 and 321.

In some embodiments, the I/O bridge 307 is coupled to a system disk 314 that may be configured to store content and applications and data for use by the processor(s) 312 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 307 as well.

In some embodiments, the memory bridge 305 may be a Northbridge chip, and the I/O bridge 307 may be a Southbridge chip. In addition, the communication paths 306 and 313, as well as other communication paths within the computing system 140, can be implemented using any technically suitable protocols, including, without limitation, AGP (Accelerated Graphics Port), HyperTransport, or any other bus or point to point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations.

The system memory 144 includes at least one device driver configured to manage the processing operations of the one or more PPUs within the parallel processing subsystem 312. In addition, the system memory 144 includes the design application 146, discussed in greater detail in conjunction with FIGS. 6 and 9. Although described herein primarily with respect to the design application 146, techniques disclosed herein can also be implemented, either entirely or in part, in other software and/or hardware, such as in the parallel processing subsystem 312.

In some embodiments, the parallel processing subsystem 312 can be integrated with one or more of the other elements of FIG. 3 to form a single system. For example, the parallel processing subsystem 312 can be integrated with the processor(s) 142 and other connection circuitry on a single chip to form a system on a chip (SoC).

In some embodiments, the processor(s) 142 includes the primary processor of the computing system 140, controlling and coordinating operations of other system components. In some embodiments, the processor(s) 142 issues commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 312, and the number of parallel processing subsystems 312, can be modified as desired. For example, in some embodiments, the system memory 144 could be connected to the processor(s) 142 directly rather than through the memory bridge 305, and other devices can communicate with system memory 144 via the memory bridge 305 and the processor(s) 142. In other embodiments, the parallel processing subsystem 312 can be connected to the I/O bridge 307 or directly to the processor(s) 142, rather than to the memory bridge 305. In still other embodiments, I/O bridge 307 and the memory bridge 305 can be integrated into a single chip instead of existing as one or more discrete devices. In certain embodiments, one or more components shown in FIG. 3 may not be present. For example, the switch 316 could be eliminated, and the network adapter 318 and add the in cards 320, 321 would connect directly to the I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in some embodiments. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Designing Systems with Multi-Objective Bayesian Optimization

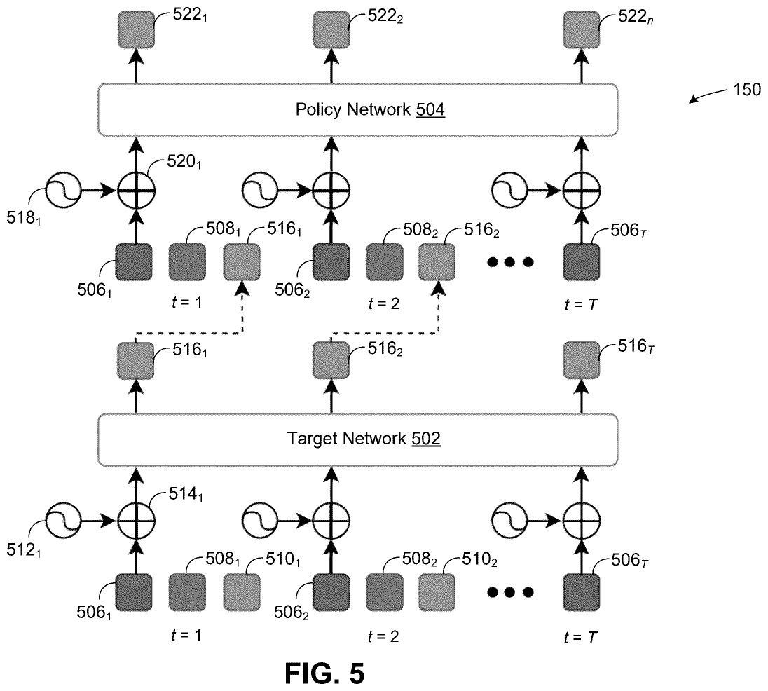

FIG. 4 is a more detailed illustration of the model trainer 116 of FIG. 1, according to various embodiments. As shown, the model trainer 116 includes a reinforcement learning module 402 and a simulator 420. In operation, the reinforcement learning module 402 trains the machine learning model 150 by updating parameters thereof, beginning from an untrained machine learning model and ending with a trained machine learning model. The machine learning model 150 is trained for use in an iterative technique for optimizing parameters of a system that accounts for multiple performance metrics, also referred to herein as multi-objective Bayesian optimization. In some embodiments, the machine learning model 150 can be a transformer-based neural network. An architecture of the machine learning model 150, according to some embodiments, is described in greater detail below in conjunction with FIG. 5.

Returning to FIG. 4, the reinforcement learning module 402 includes a loss computation module 408 and an actor selector 414. In some embodiments, training of the machine learning model 150 includes, for each of a number of iterations during an episode, (1) processing historical data 404 using the machine learning model 150 to generate predicted rewards 406 for actions that represent designs of a system using different parameter values; (2) selecting, by the action selector 414, one of the actions that is associated with a highest predicted reward in the predicted rewards for actions 406, and (3) updating 416 the historical data 404 based on the selected action. In addition, training of the machine learning model 150 includes, for each episode, (1) computing, by the loss computation module 408, a loss 410 based on a comparison between the predicted rewards for actions 406 during the episode and rewards for actions from simulations of those actions by the simulator 420; and (2) updating 412 parameters of the machine learning model 150 based on the computed loss 410. Any suitable system parameters can be used, and the parameters that are used for a given system will generally depend on a type of the given system. For example, when the system is an integrated circuit, the parameters can include a bias current, a number of resistors, a number of capacitors, a width/length (W/L) ratio, and/or the like. In some embodiments, the rewards 406 that are predicted for actions can be normalized hypervolume improvements, discussed in greater detail below.

In some embodiments, the historical data 404 includes, (1) for each previous time step, an action selected for the time step and subsequent state (also referred to herein as an “observation”) of the system (i.e., an observation-action pair), a reward r for the action computed using the simulator 420, a reward Q predicted by the machine learning model 150 for the action. In some embodiments, all the past observation-action pairs are concatenated. The reinforcement learning module 402 inputs (1) historical data 404 and (2) for a current time step, possible actions and resulting states of the system (i.e., potential observation-action pairs) after the actions (not shown), into the machine learning model 150, which outputs predicted rewards 406, Q's, for each possible action for the current time step.

The action selector 414 selects one of the actions that is associated with a highest predicted reward in the predicted rewards for actions 406 and updates 416 the historical data 404 to include, for the current time step, the selected action and a state of the system after the selected action (i.e., an observation-action pair for the current time step), the reward for the selected action computed using the simulator 420, and the highest predicted reward associated with the selected action. The updated historical data 404 can then be input into the machine learning model 150 again, along with potential observation-action pairs, during another iteration of an episode. Each episode can execute for a certain number of iterations (e.g., 100 iterations), and any suitable number of episodes of training can be performed in some embodiments.

For each episode, the loss computation module 408 computes the loss 410 based on a comparison of the predicted rewards of actions 406 that are output by the machine learning model 150 during the episode and rewards of the same actions that are computed using the simulator 420 during the episode. Any technically feasible simulator 420 can be used in some embodiments. The particular simulator that is used will generally depend on the type of system being designed. Returning to the example of the system being an integrated circuit, a circuit simulator can be used to determine the rewards for actions associated with designs of the integrated circuit with different combinations of parameter values. Using the loss 410, the reinforcement learning module 402 updates parameters of the machine learning model 150. The machine learning model parameters can be updated in any technically feasible manner in some embodiments, such as using backpropagation with gradient descent, or a variation thereof.

After the episode, if model trainer 116 determines to continue training, then the historical data 404 can be re-initialized to an empty history at the beginning of a next episode, and training can be performed as described above, until the certain number of iterations for the episode have been performed, the loss 410 has been computed, and the machine learning model 150 has been updated based on the loss. The foregoing then can be repeated for any suitable number of training episodes.

More formally, let Δ( [symbol] ) denote the set of all probability distributions over a set [symbol] and [K] be a shorthand for {1, . . . , K}. The goal of multi-objective Bayesian optimization is to sequentially take samples from the input domain X⊂ [symbol] ^{d} as inputs to jointly optimize a black-box vector-valued function ƒ: X→ [symbol] ^{K}, under a sampling budget T∈ [symbol] . For ease of exposition, ƒ(x):=(ƒ₁(x), . . . , ƒ_{K}(x)) is used herein as the tuple of the K scalar objective functions, for each x∈X. At each step t, the parameter optimization module 602 selects a sample point xₜ∈X and observes the corresponding function values yₜ:=(yₜ⁽¹⁾, . . . , yₜ^{(K)}, where yₜ⁽¹⁾=ƒ₁(xₜ)+ε_{t,4} is the noisy observation of the i-th entry of the function output and ε_{t,i}'s are independent and identically distributed zero-mean Gaussian noises. For notational convenience, [symbol] ₜ:={(xᵢ, yᵢ)}_{i∈[t]} is used herein to denote the observations up to t.

To construct a (partial) ordering over the points of the input domain, ƒ(x) dominates ƒ(x′) if ƒ₁(x)≥ƒ₁(x′) for all i∈[K] and ƒⱼ(x)>ƒ_{ƒ}(x′) for at least one element j. For simplicity, the notation x [symbol] x′ is used herein if ƒ(x) dominates ƒ(x′). Based on the foregoing, the Pareto front (denoted by [symbol] *) is defined as the subset of X that cannot be dominated by any other point in X, i.e., [symbol] *:={x∈X|x′>x, ∀x′∈X}. An alternative description of the goal of multi-objective Bayesian optimization is to discover the Pareto front. Accordingly, multi-objective Bayesian optimization can be evaluated from the perspective of hypervolume, which offers a natural performance metric for capturing the inherent trade-off among different objective functions. Specifically, given a reference point u∈ [symbol] ^{K} and any subset [symbol] ⊆X, the hypervolume of [symbol] is defined as:

$$HV ( 𝒳 ; u ) : = λ ( {⋃}_{y ∈ {ℝ}^{κ}} \{ {x}^{′} \vert f ( x ) ≻ y ≻ u , x ∈ 𝒳 \} ) \qquad ( 1 )$$

where λ(-) is the K-dimensional Lebesgue measure. In practice, the reference point can be configured as u=(min_{x∈X}ƒ₁(x), . . . , min_{x∈X}ƒₖ(x)). To evaluate a policy, consider the simple regret defined as [symbol] (t):=HV(X)−HV( [symbol] ₜ), which measures the overall performance of the samples up to time step t. For brevity, HV( [symbol] ) is used herein as a shorthand for HV( [symbol] ; u) in the sequel.

To maximize hypervolume in a sample-efficient manner, multi-objective Bayesian optimization can impose a function prior through Gaussian processes, which serves as a surrogate probabilistic model for capturing the underlying structure of the objective functions. Specifically, as a Bayesian approach, the Gaussian processes assumes that for each objective function ƒ₁(⋅), the function values at any set of input points form a multivariate Gaussian distribution, which can be fully characterized by a mean function and a covariance kernel. Therefore, under a Gaussian processes prior, given the observations [symbol] ₜ up to time t, the posterior predictive distribution of each ƒₜ(x)(x∈K) remains Gaussian and can be written as [symbol] (μₜ⁽¹⁾(x), σₜ^{(t)}(x)²), where μₜ⁽¹⁾(x):= [symbol] [ƒₜ(x)| [symbol] ₜ] and σₜ⁽¹⁾(x):= [symbol] can be derived in closed form through matrix operations. For notational convenience, let μₜ(x):=(μₜ⁽¹⁾(x), . . . , μₜ^{(k)}(x)) and σₜ(x):=(σₜ⁽¹⁾(x), . . . , σₜ^{(K)}(x).

In some embodiments, the model trainer 116 can use the general reinforcement learning formulation to address policy learning beyond Markovianity. The general interaction protocol of the agent and the environment can be described as follows. Let [symbol] and [symbol] denote the set of actions and observations, respectively. At each time t∈ [symbol] , the agent first receives a new observation [symbol] ₜ∈ [symbol] from the environment and takes an action Aₜ∈ [symbol] based on the history Hₜ:=(A₀, O₁, A₁, . . . , Aₜ₋₁, Oₜ) observed so far. For simplicity, let the initial history H₀ be empty. Also, let the set of all n-step histories be [symbol] ⁽ⁿ⁾:=( [symbol] × [symbol] )ⁿ, and accordingly define the set of all finite histories as [symbol] :=∪_{n≥0} [symbol] ⁽ⁿ⁾. The transition dynamics of the environment can be captured by the transition function p: [symbol] × [symbol] →Δ( [symbol] ), which determines the transition probability p (o|h, a)≡ [symbol] (Oₜ₊₁=o|Hₜ=h, Aₜ=a) of observing o upon applying action a under history h. Moreover, let r: [symbol] × [symbol] × [symbol] →[−rₘₐₓ, rₘₐₓ] denote the reward function. Notably, the reward function r in non-Markovian environments is allowed to be history-dependent and hence better suits multi-objective Bayesian optimization problems. Let γ∈[0,1) denote the discount factor for the rewards.

During optimization, the agent specifies a strategy through a policy π: [symbol] →Δ( [symbol] ), which maps each history to a probability distribution over the action set. Let IT denote the set of all policies. Value functions can be defined that reflect the long-term benefit of following a policy π. Given a t-step history h∈ [symbol] ,

$${V}^{π} ( h ) := {E}_{π} [ {\sum }_{t = τ}^{∞} {γ}^{t - τ} r ( {H}_{t} , {A}_{t} , {O}_{t + 1} ) \vert {H}_{τ} = h ] , \qquad ( 2 )$$

$${Q}^{π} ( h , a ) := {E}_{π} [ {\sum }_{t = τ}^{∞} {γ}^{t - τ} r ( {H}_{t} , {A}_{t} , {O}_{t + 1} ) \vert {H}_{τ} = h , {A}_{τ} = a ] .$$

Moreover, the definitions of the optimal value functions in Markov decision processes can be extended to the non-Markovian setting as

$${V}^{*} ( h ) := {sup}_{π ∈ Π} {V}^{π} ( h ) , {Q}^{*} ( h , a ) := {sup}_{π ∈ Π} {Q}^{π} ( h , a ) . \qquad ( 3 )$$

The following proposition offers a generalized version of the Bellman optimality equations and characterizes V* and Q*. Proposition: The pair of (V*, Q*) is the unique solution to the following system of equations:

$$V ( h ) = {max}_{{a}^{′} ∈ 𝒜} Q ( h , {a}^{′} ) \qquad ( 4 )$$

$$Q ( h , a ) = {𝔼}_{o ∼ p ( \cdot \vert h , a ) , {h}^{′} = ( h , a , o )} [ r ( h , a , o ) + γ V ( {h}^{′} ) ] ,$$

where V: [symbol] → [symbol] and Q: [symbol] × [symbol] → [symbol] are bounded real-valued functions. Motivated by the optimality equations in (3)-(4), these fundamental properties can be converted into a learning algorithm. For the loss function of the learning algorithm, to learn Q*, the loss function of the standard deep Q-network can be adapted to the generalized non-Markovian version by minimizing the residual of the optimality equation. Let Q_{θ}(h, a) denote the parameterized Q-function. Then, the loss function of the generalized deep Q-network can be designed as

$${𝔼}_{( h , a , o ) ∼ 𝒟} [ {( r ( h , a , o ) + γ {max}_{{a}^{′} ∈ 𝒜} {Q}_{\overline{θ}} ( {h}^{′} , {a}^{′} ) - {Q}_{θ} ( h , a ) )}^{2} ] , \qquad ( 5 )$$

where [symbol] is the underlying distribution of the observed histories during training, h′=(h, a, o) is the history for the next Q-value, and Q_{θ̅} is a copy of Q_{θ} with parameters frozen.

To implement the loss function of equation (5), some embodiments leverage sequence modeling (e.g., transformers) and directly use the full observations as the input of the sequence models. In the context of learning acquisition functions for multi-objective Bayesian optimization, one can apply this design principle and extend the representation design of acquisition functions for single-objective Bayesian optimization to the multi-objective Bayesian optimization setting, and doing so amounts to taking the posterior distributions of all K objective functions at all the domain points along with {yₜ^{(t)}*:=argmax_{j≤t-1}yⱼ^{(t)}}₁₋₁^{K} the best function values observed so far as the per-step observation, i.e., o≡{μ⁽¹⁾(x), σ^{(t)}(x), y⁽¹⁾}_{x∈X,t∈[K]}. While being a natural variant of transformer-based reinforcement learning, such an implementation of the generalized deep Q-network framework can be problematic in multi-objective Bayesian optimization for two reasons: (i) Limited cross-domain transferability: as the observation representation is domain dependent under such a design, the learned model is tied closely to the training domain and has very limited transferability. As a result, retraining or customization is needed for every task at deployment. (ii) Scalability issue in sequence length and memory requirement: Under this design, the sequence length can grow linearly with the number of domain points and pose a stringent requirement on the hardware memory for training. Indeed, the domain size is at least on the order of thousands in practical Bayesian optimization problems.

To tackle the above issues, the machine learning model 150 can use an alternative design that better substantiates the Generalized DQN framework for multi-objective Bayesian optimization with domain-agnostic representations and several practical enhancements. In particular, to avoid the issues of the direct implementation, the machine learning model 150 is built on the following enhancements. Q-Augmented Representation: Define

$${y}_{t}^{( 1 ) *} := {argmax}_{1 \leq j \leq t} {y}_{i}^{( t )} , ∀ i ∈ [ 1 , … , K ] . \qquad ( 6 )$$

as the best observed function value of j-th objective at time t. Moreover, for each domain point x∈X, let oₜ(x) denote the observation for x as

$${o}_{t} ( x ) ≡ {\{ {μ}_{t}^{( 1 )} ( x ) , {σ}_{t}^{( 1 )} ( x ) , {y}_{t}^{( 1 )} , \frac{1}{T} \}}_{t ∈ [ K ]} .$$

Moreover, some embodiments use the normalized hypervolume improvement as the reward, i.e.,

$${r}_{c} := \frac{HV ( {𝒳}_{t} ) - HV ( {𝒳}_{t - 1} )}{HV ( {𝒳}^{*} ) - HV ( {𝒳}_{t} )} . \qquad ( 7 )$$

Then, hₜ, the history up to time t, is the concatenation of past observation-action pair representation defined as follows:

$${h}_{t} = {\{ {μ}_{j}^{( t )} ( {x}_{j} ) , {σ}_{j}^{( t )} ( {x}_{j} ) , {y}_{j - 1}^{( t ) *} , j / t , {r}_{i} , {Q}_{θ} \}}_{1 ∈ [ k ] , j ∈ [ t - 1 ]} . \qquad ( 8 )$$

Notably, under this design, the representation is domain-agnostic and memory-efficient in the sense that its dimension does not increase with the domain size.

FIG. 5 is a more detailed illustration of the machine learning model 150 of FIG. 1, according to various embodiments. As shown, the machine learning model 150 includes a target network 502 and a policy network 504. Each of the target network 502 and the policy network 504 can be an artificial neural network that includes one or more layers of neurons.

Illustratively, the machine learning model 150 takes as input, for each of a number of time steps including a current time step T, an observation-action pair 506₁ to 506_{T} (referred to herein collectively as observation-action pairs 506 and individually as an observation-action pair 506). In addition, the machine learning model 150 takes as input, for each of a number of previous time steps 1 to T−1, rewards from simulations 508₁ to 508_{T-1} (referred to herein collectively as rewards 508 and individually as a reward 508) that were performed to test the effects of actions 506₁ to 506_{T-1}, respectively, and rewards 510₁ to 510_{T-1} predicted by the machine learning model 150 (referred to herein collectively as predicted rewards 510 and individually as a predicted reward 510). The observation-action pairs 506 are also added to positional encodings using element-wise addition. For example, the observation-action pair 506₁ is added to a positional encoding 512₁ via an element-wise addition 514₁. Given such inputs, the target network 502 outputs predicted rewards (also referred to herein as Q-values) for past observation-action pairs 516₁ to 516_{T-1} (referred to herein collectively as predicted past rewards 516 and individually as a predicted past reward 516).

The predicted past rewards 516 for previously time steps 1 to T−1 are then input, along with the observation-action pairs 506 and the rewards 508 for the previous time steps 1 to T−1, as well as the observation-action pair 506_{T} for a current time step, into the policy network 504. Further, the observation-action pairs 506 are added to positional encodings using element-wise addition before being input into the policy network 504. For example, the observation-action pair 506₁ is added to a positional encoding 518₁ via an element-wise addition 520₁. Given such inputs, the policy network 504 outputs predicted rewards for possible actions 522₁ to 522ₙ (referred to herein collectively as predicted rewards 522 and individually as a predicted reward 522).

Notably, the machine learning model 150 can be used as an acquisition function for multi-objective Bayesian optimization. More formally, denote Q_{θ}(⋅): [symbol] ^{(t-1)}× [symbol] to be the function of the machine learning model 150 parameterized by θ and let \hat{θ} represent the parameters of the machine learning model 150. The selected point xₜ satisfies that xₜ:=argmax_{x∈X}Q_{θ̅}(hₜ, oₜ(x)). Then, Q_{θ̅} considered in hₜ can be implemented by a target network. In non-Markovian version of deep Q-learning, Q_{θ̅} can be defined recursively, where:

$${Q}_{\overline{θ}} ( {h}_{t} , {o}_{t} ( {x}_{t} ) ) := {Q}_{θ} ( {\{ {o}_{t} ( {x}_{t} ) , {r}_{t} , {Q}_{θ} ( {h}_{t - 1} , {o}_{t - 1} ( {x}_{t - 1} ) ) \}}_{t - 1}^{t - 1} , {o}_{t} ( {x}_{t} ) ) . \qquad ( 9 )$$

For off-policy learning, the concept of Prioritized Experience Replay can be extended using a prioritized trajectory replay buffer. The detailed modifications are as follows: (i) Elements pushed into the prioritized trajectory replay buffer are entire trajectories τ={oᵢ(xᵢ), rᵢ}₋₁^{T}. (ii) The TD-error considered in PER is replaced by δ(Q_{θ}_{ᵢ}, τ), which is the summation of the TD-error of the policy network for all transitions in this trajectory, i.e.,

$$δ ( Q , t ) := {\sum }_{i = 1}^{T - 1} {( Q ( {h}_{i} , {o}_{i} ( {x}_{i} ) ) - ( {r}_{i} + γ {max}_{x ∈ X} {Q}_{∅} ( {h}_{i + 1} , {o}_{i + 1} ( x ) ) ) )}^{2} . \qquad ( 10 )$$

Let B denote the batch sampled from a prioritized trajectory replay buffer. The loss function for training the machine learning model 150 can be defined as L(θ):=Σ_{τ∈B}δ(Q_{θ}, τ).

FIG. 6 is a more detailed illustration of the design application 146 of FIG. 1, according to various embodiments. As shown, the design application 146 includes a parameter optimization module 602 and a simulator 620. The parameter optimization module 602 includes the trained machine learning model 150 and an action selector module (action selector) 608. In operation, the design application 146 performs multi-objective Bayesian optimization to generate a design by, for each of a number of iterations, (1) processing historical data 604 using the machine learning model 150 to generate predicted rewards 606 of actions that represent designs of a system using different parameter values; (2) selecting, by the action selector 608, one of the actions that is associated with a highest predicted reward in the predicted rewards for actions 606, (3) simulating the action using the simulator 620, and (4) updating 610 the historical data 604 with the selected action and the state of the design after the action (i.e., the selected observation-action pair for the current time step), the predicted reward for the action, and the simulation results.

In some embodiments, the historical data 604 includes, (1) for each previous time step, an action selected for the time step and subsequent state (i.e., an observation) of the system (i.e., an observation-action pair), a reward r for the action computed using the simulator 620, a reward Q predicted by the machine learning model 150 for the action. In some embodiments, all the past observation-action pairs are concatenated. The parameter optimization module 602 inputs (1) historical data 604 and (2) for a current time step, possible actions and resulting states of the system (i.e., potential observation-action pairs) after the actions (not shown), into the machine learning model 150, which outputs predicted rewards 606, Q's, for each possible action for the current time step.

The action selector 608 selects one of the actions that is associated with a highest predicted reward in the predicted rewards for actions 606. The simulator 620 computes a reward for the selected action. Any technically feasible simulator 620 can be used in some embodiments. The particular simulator that is used will generally depend on the type of system being designed. Returning to the example of the system being an integrated circuit, a circuit simulator can be used to determine the rewards for actions associated with designs of the integrated circuit with different combinations of parameter values.

The action selector 608 further updates 610 the historical data 604 to include, for the current time step, the selected action and a state of the system after the selected action (i.e., the selected observation-action pair for the current time step), the reward for the selected action computed using the simulator 620, and the highest predicted reward associated with the selected action. The updated historical data 604 can then be input into the machine learning model 150 again during another iteration of the optimization. Any number of iterations of optimization can be performed in some embodiments, such as a fixed number (e.g., 100) of iterations.

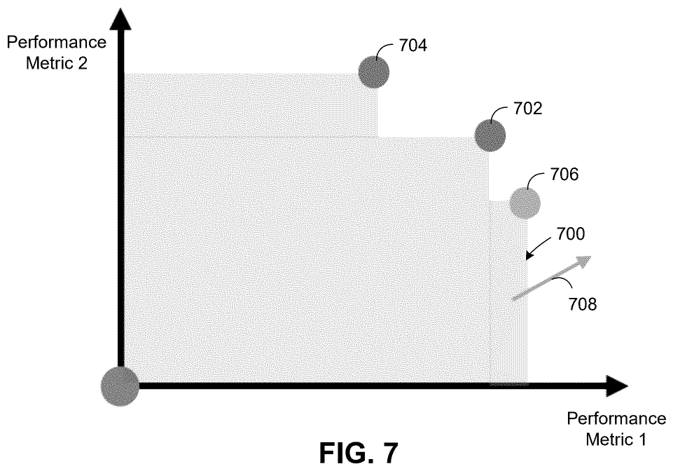

FIG. 7 illustrates an exemplar sequence of actions that increases a hypervolume, according to various embodiments. As shown, when optimizing parameters for a system, a hypervolume 700 is a two-dimensional space contained by a set of points that can be used as an indicator of the performance of optimization. For example, when the system is a capacitor in an operational amplifier (OpAmp), one of the parameters can be a size of the capacitor, and performance metrics 1 and 2 that are used to assess designs of the capacitor can be gain and unity-gain bandwidth. In such cases, the hypervolume 700 can be the volume corresponding to a point that represents an action associated with a particular set of parameter values (e.g., a particular capacitor size). More generally, the hypervolume can be an n-dimensional space when n parameters are used, and the goal of optimization is to find the Pareto front of Pareto optimal points that maximize the hypervolume. In some embodiments, historical data can be repeatedly processed using the machine learning model 150 to predict rewards of possible actions and select an action with the highest predicted reward, as described above in conjunction with FIG. 6. Illustratively, actions 702, 704, and 706 have been selected in such a manner, with each of the actions 702, 704, and 706 increasing the hypervolume 700. Notably, an increase 708 in the hypervolume 700 for the action 706 depends on the sampling history, so consideration of the historical data using the machine learning model 150 can result in smarter sampling that improves the speed at which optimal parameter values are identified.

FIG. 8 is a flow diagram of method steps for training a machine learning model to design a system, according to various embodiments. Although the method steps are described in conjunction with FIGS. 1-5 and 7, persons skilled in the art will understand that any system configured to perform the method steps, in any order, falls within the scope of the present invention.

As shown, a method 800 begins at step 802, where the model trainer 116 initializes historical data for an episode of training. In some embodiments, the historical data can be as described above in conjunction with FIGS. 4-5. In some embodiments, the historical data can be initialized to empty.

At step 804, the model trainer 116 processes the historical data and potential observation-action pairs using a machine learning model to predict rewards associated with actions in the potential observation-action pairs. In some embodiments, the machine learning model can be a transformer-based neural network having the architecture described above in conjunction with FIG. 5. Given the historical data and potential observation-action pairs for a current time step as input, such a machine learning model outputs predicted rewards for the actions of the potential observation-action pairs, as described above in conjunction with FIG. 4.

At step 806, the model trainer 116 determines whether to continue the current episode of training. In some embodiments, each episode can continue for a certain number of iterations (e.g., 100 iterations).

If the model trainer 116 determines to continue the current episode, then at step 808, the model trainer 116 selects an action associated with a highest predicted reward and updates the historical data based on the selected action. In some embodiments, the model trainer 116 can update the historical data with the selected action and a state of the system after the selected action (i.e., the selected observation-action pair for the current time step), the predicted reward for the action, and the simulation reward for the action, as described above in conjunction with FIG. 4. The method 800 then returns to step 804, where the model trainer 116 processes the updated historical data and potential observation-action pairs using the machine learning model to predict rewards associated with actions in the potential observation-action pairs.

On the other hand, if the model trainer 116 determines to not continue the current episode, then the method 800 continues to step 810, where the model trainer 116 computes a loss based on a comparison between the predicted rewards for actions during the episode and rewards for actions from simulations of those actions. Any technically feasible simulator can be used in some embodiments. The particular simulator that is used will generally depend on the type of system being designed.

At step 812, the model trainer 116 updates parameters of a machine learning model based on the computed loss. The machine learning model parameters can be updated in any technically feasible manner in some embodiments, such as using backpropagation with gradient descent, or a variation thereof.

At step 814, the model trainer 116 determines whether to continue training. If the model trainer 116 determines to stop training, then the method 800 ends. For example, the model trainer 116 could stop training after a certain number of episodes or if continued training does significantly not improve the loss, described above in conjunction with step 810. On the other hand, if the model trainer 116 determines to continue training, then the method 800 returns to step 802, where the model trainer 116 re-initializes the historical data for another episode of training.

FIG. 9 is a flow diagram of method steps for designing a system using a trained machine learning model, according to various embodiments. Although the method steps are described in conjunction with FIGS. 1-5 and 7, persons skilled in the art will understand that any system configured to perform the method steps, in any order, falls within the scope of the present invention.

As shown, a method 900 begins at step 902, where the design application 146 initialize historical data. In some embodiments, the historical data can be as described above in conjunction with FIG. 6. In some embodiments, the historical data can be initialized to empty.

At step 904, the design application 146 processes the historical data and potential observation-action pairs using a trained machine learning model to predict rewards for actions in the potential observation-action pairs. In some embodiments, the machine learning model can be a transformer-based neural network having the architecture described above in conjunction with FIG. 5, and the machine learning model can be trained according to the method 800, described above in conjunction with FIG. 8. Given the historical data and the potential observation-action pairs as input, the machine learning model outputs predicted rewards for the actions of the observation pairs, as described above in conjunction with FIG. 6.

At step 906, the design application 146 selects one of the actions that is associated with a highest predicted reward.

At step 908, the design application 146 computes a reward for the selected action using a simulator. Any technically feasible simulator can be used in some embodiments. The particular simulator that is used will generally depend on the type of system being designed.

At step 910, the design application 146 determines whether to continue optimizing the design of the system. Any technically feasible termination criteria can be used to determine whether to continue optimizing the design in some embodiments. For example, in some embodiments, the design application 146 can iteratively optimize the design of the system for a predefined of actions (e.g., 100 actions for an episode). As another example, in some embodiments, the design application 146 can iteratively optimize the design of the system until the predicted rewards for actions do not improve for more than a threshold amount over successive actions.

If the design application 146 determines to continue optimizing the design of the system, then at step 912, the design application 146 updates the historical data based on the action selected at step 906. In some embodiments, the design application 146 can update the historical data with the selected action and a state of the system after the selected action (i.e., the selected observation-action pair for the current time step), the predicted reward for the action, and the simulation reward for the action, as described above in conjunction with FIG. 6. Then, the method 900 returns to step 904, where the design application 146 processes, for another time step, the updated historical data and potential observation-action pairs using the trained machine learning model to predict the rewards for actions from the potential observation-action pairs.

On the other hand, if the design application 146 determines to stop optimizing the design of the system, then the method 900 ends. Thereafter, the design of the system that has been optimized, including the parameter values of such a design, can be displayed to a user via a display device, used to manufacture or otherwise create the design, or utilized in any other technically feasible manner. For example, the design and associated parameter values could be displayed in a user interface that permits a user to modify the parameter values and/or accept the parameter values for use in the design of a system that can then be manufactured.

In sum, techniques are disclosed for training and using a machine learning model to design systems, such as integrated circuits. In some embodiments, the machine learning model is a transformer-based neural network that a model trainer trains for a number of episodes. During each episode, the model trainer trains the machine learning model by, for each of a number of iterations, processing historical data and potential observation-action pairs using the machine learning model to predict rewards for actions that represent designs of a system using different parameter values, and updating the historical data based on the action associated with the highest predicted reward. In addition, for each episode, the model trainer computes a loss based on a comparison between the predicted rewards during the episode and rewards for the actions that are computed using a simulator, and then the model trainer updates parameters of the machine learning model based on the computed loss. Once training is complete, a design application can use the trained machine learning model to optimize the design of a system by, for each of a number of iterations, processing historical data and potential observation-action pairs using the trained machine learning model to predict rewards for actions that represent designs of the system using different parameter values, selecting an action associated with the highest predicted reward, computing a reward for the selected action using a simulation, and updating the historical data with the selected action and resulting design, the highest predicted reward, and the simulation reward.

At least one technical advantage of the disclosed techniques relative to the prior art is that, with the disclosed techniques, more optimal parameter values for a system can be selected relative to manual trial-and-error, resulting in improved performance of the system being designed across multiple performance criteria. In addition, the automatic optimization can converge to a solution relatively quickly by accounting for the history of previous designs that have been considered during optimization. These technical advantages represent one or more technological improvements over prior art approaches.
1. In some embodiments, a computer-implemented method for designing a system comprises processing historical data associated with zero or more previous designs of the system using a trained machine learning model to predict a plurality of rewards for a plurality of designs of the system that are associated with different combinations of parameter values, and selecting, from the plurality of designs of the system, a first design of the system that is associated with a highest reward included in the plurality of rewards.
2. The computer-implemented method of clause 1, further comprising simulating the first design of the system to compute a simulation reward.
3. The computer-implemented method of clauses 1 or 2, wherein the historical data is processed using the trained machine learning model along with the plurality of designs and a plurality of actions associated with the plurality of designs.
4. The computer-implemented method of any of clauses 1-3, wherein the trained machine learning model comprises a transformer-based neural network.
5. The computer-implemented method of any of clauses 1-4, wherein the trained machine learning model comprises a first neural network that predicts one or more intermediate rewards for the one or more previous designs of the system and a second neural network that predicts the plurality of rewards based on the historical data and the one or more intermediate rewards.
6. The computer-implemented method of any of clauses 1-5, further comprising updating the historical data based on the first design of the system to generate updated historical data, processing the updated historical data using the trained machine learning model to predict another plurality of rewards associated with another plurality of designs of the system, and selecting, from the another plurality of designs of the system, a second design of the system that is associated with a highest reward included in the another plurality of rewards.
7. The computer-implemented method of any of clauses 1-6, wherein each reward included in the plurality of rewards represents a normalized hypervolume improvement.
8. The computer-implemented method of any of clauses 1-7, wherein the trained machine learning model is generated based on a loss that compares at least one reward predicted by the untrained machine learning model and at least one other reward computed via simulation.
9. The computer-implemented method of any of clauses 1-8, wherein the system comprises one of an integrated circuit or a machine learning model training application.
10. The computer-implemented method of any of clauses 1-9, wherein the parameter values include values for at least one of a bias current, a number of resistors, a number of capacitors, or a width/length (W/L) ratio of an integrated circuit.
11. In some embodiments, one or more non-transitory computer-readable storage media include instructions that, when executed by at least one processor, cause the at least one processor to perform steps for designing a system, the steps comprising processing historical data associated with zero or more previous designs of the system using a trained machine learning model to predict a plurality of rewards for a plurality of designs of the system that are associated with different combinations of parameter values, and selecting, from the plurality of designs of the system, a first design of the system that is associated with a highest reward included in the plurality of rewards.
12. The one or more non-transitory computer-readable storage media of clause 11, wherein the instructions, when executed by the at least one processor, further cause the at least one processor to perform the step of simulating the first design of the system to compute a simulation reward.
13. The one or more non-transitory computer-readable storage media of clauses 11 or 12, wherein the trained machine learning model comprises a transformer-based neural network.
14. The one or more non-transitory computer-readable storage media of any of clauses 11-13, wherein the historical data is processed using the trained machine learning model along with the plurality of designs and a plurality of actions associated with the plurality of designs.
15. The one or more non-transitory computer-readable storage media of any of clauses 11-14, wherein the instructions, when executed by the at least one processor, further cause the at least one processor to perform the steps of updating the historical data based on the first design of the system to generate updated historical data, processing the updated historical data using the trained machine learning model to predict another plurality of rewards associated with another plurality of designs of the system, and selecting, from the another plurality of designs of the system, a second design of the system that is associated with a highest reward included in the another plurality of rewards.
16. The one or more non-transitory computer-readable storage media of any of clauses 11-15, wherein the trained machine learning model is generated via one or more reinforcement learning operations based on a loss that compares at least one reward predicted by the untrained machine learning model and at least one reward computed via simulation.
17. The one or more non-transitory computer-readable storage media of any of clauses 11-16, wherein the historical data includes for each time step included in one or more previous time steps, a previous design and associated action selected for the time step, a reward for the previous design computed via simulation, and a reward predicted by the trained machine learning model for the previous design, and for a current time step, the plurality of designs and actions.
18. The one or more non-transitory computer-readable storage media of any of clauses 11-17, wherein each reward included in the plurality of rewards accounts for a plurality of performance metrics.
19. The one or more non-transitory computer-readable storage media of any of clauses 11-18, wherein each reward included in the plurality of rewards accounts for at least one of a gain, a unity-gain bandwidth, or a power consumption of an integrated circuit.
20. In some embodiments, a system comprises one or more memories storing instructions, and one or more processors that are coupled to the one or more memories and, when executing the instructions, are configured to process historical data associated with zero or more previous designs of the system using a trained machine learning model to predict a plurality of rewards for a plurality of designs of the system that are associated with different combinations of parameter values, and select, from the plurality of designs of the system, a first design of the system that is associated with a highest reward included in the plurality of rewards.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for designing a system, the method comprising:
processing historical data associated with zero or more previous designs of the system using a trained machine learning model to predict a plurality of rewards for a plurality of designs of the system that are associated with different combinations of parameter values; and
selecting, from the plurality of designs of the system, a first design of the system that is associated with a highest reward included in the plurality of rewards.

2. The computer-implemented method of claim 1, further comprising simulating the first design of the system to compute a simulation reward.

3. The computer-implemented method of claim 1, wherein the historical data is processed using the trained machine learning model along with the plurality of designs and a plurality of actions associated with the plurality of designs.

4. The computer-implemented method of claim 1, wherein the trained machine learning model comprises a transformer-based neural network.

5. The computer-implemented method of claim 1, wherein the trained machine learning model comprises a first neural network that predicts one or more intermediate rewards for the one or more previous designs of the system and a second neural network that predicts the plurality of rewards based on the historical data and the one or more intermediate rewards.

6. The computer-implemented method of claim 1, further comprising:
updating the historical data based on the first design of the system to generate updated historical data;
processing the updated historical data using the trained machine learning model to predict another plurality of rewards associated with another plurality of designs of the system; and
selecting, from the another plurality of designs of the system, a second design of the system that is associated with a highest reward included in the another plurality of rewards.

7. The computer-implemented method of claim 1, wherein each reward included in the plurality of rewards represents a normalized hypervolume improvement.

8. The computer-implemented method of claim 1, wherein the trained machine learning model is generated based on a loss that compares at least one reward predicted by the untrained machine learning model and at least one other reward computed via simulation.

9. The computer-implemented method of claim 1, wherein the system comprises one of an integrated circuit or a machine learning model training application.

10. The computer-implemented method of claim 1, wherein the parameter values include values for at least one of a bias current, a number of resistors, a number of capacitors, or a width/length (W/L) ratio of an integrated circuit.

11. One or more non-transitory computer-readable storage media including instructions that, when executed by at least one processor, cause the at least one processor to perform steps for designing a system, the steps comprising:
processing historical data associated with zero or more previous designs of the system using a trained machine learning model to predict a plurality of rewards for a plurality of designs of the system that are associated with different combinations of parameter values; and
selecting, from the plurality of designs of the system, a first design of the system that is associated with a highest reward included in the plurality of rewards.

12. The one or more non-transitory computer-readable storage media of claim 11, wherein the instructions, when executed by the at least one processor, further cause the at least one processor to perform the step of simulating the first design of the system to compute a simulation reward.

13. The one or more non-transitory computer-readable storage media of claim 11, wherein the trained machine learning model comprises a transformer-based neural network.

14. The one or more non-transitory computer-readable storage media of claim 11, wherein the historical data is processed using the trained machine learning model along with the plurality of designs and a plurality of actions associated with the plurality of designs.

15. The one or more non-transitory computer-readable storage media of claim 11, wherein the instructions, when executed by the at least one processor, further cause the at least one processor to perform the steps of:
updating the historical data based on the first design of the system to generate updated historical data;
processing the updated historical data using the trained machine learning model to predict another plurality of rewards associated with another plurality of designs of the system; and
selecting, from the another plurality of designs of the system, a second design of the system that is associated with a highest reward included in the another plurality of rewards.

16. The one or more non-transitory computer-readable storage media of claim 11, wherein the trained machine learning model is generated via one or more reinforcement learning operations based on a loss that compares at least one reward predicted by the untrained machine learning model and at least one reward computed via simulation.

17. The one or more non-transitory computer-readable storage media of claim 11, wherein the historical data includes:
for each time step included in one or more previous time steps, a previous design and associated action selected for the time step, a reward associated with the previous design computed via simulation, and a reward predicted by the trained machine learning model; and
for a current time step, the plurality of designs and a plurality of associated actions.

18. The one or more non-transitory computer-readable storage media of claim 11, wherein each reward included in the plurality of rewards accounts for a plurality of performance metrics.

19. The one or more non-transitory computer-readable storage media of claim 11, wherein each reward included in the plurality of rewards accounts for at least one of a gain, a unity-gain bandwidth, or a power consumption of an integrated circuit.

20. A system, comprising:
one or more memories storing instructions; and
one or more processors that are coupled to the one or more memories and, when executing the instructions, are configured to:
process historical data associated with zero or more previous designs of the system using a trained machine learning model to predict a plurality of rewards for a plurality of designs of the system that are associated with different combinations of parameter values, and
select, from the plurality of designs of the system, a first design of the system that is associated with a highest reward included in the plurality of rewards.
